(19) United States
(12) Patent Application Publication
(10) Pub. No.: US 2021/0188091 A1
(43) Pub. Date: Jun. 24, 2021

(54) HIDDEN SWITCH EMBEDDED IN SOFT THERMOPLASTIC ELASTOMER OR POLYURETHANE AND METHOD OF MAKING

(71) Applicant: Inteva Products, LLC, Troy, MI (US)

(72) Inventors: David Whitehead, Rochester Hills, MI (US); Thomas Sybrandy, Washington, MI (US); Aidano Nascimento, Rochester Hills, MI (US); Tyler Bame, Clawson, MI (US); David Kovac, Warren, MI (US)

(21) Appl. No.: 17/121,376

(22) Filed: Dec. 14, 2020

Related U.S. Application Data
(60) Provisional application No. 62/953,314, filed on Dec. 24, 2019.
(60) Provisional application No. 62/953,316, filed on Dec. 24, 2019.

(51) Int. Cl. B60K 37/06; B60K 37/02; B60K 35/00

(52) U.S. Cl. CPC B60K 37/06; B60K 37/02; B60K 2370/98; B60K 2370/119; B60K 2370/332; B60K 35/00

(57) ABSTRACT

An assembly, the assembly including: an injection molded structural electronic component, the injection molded structural electronic component including a non-moveable switch and an illuminating device; a layer of polyurethane or thermoplastic elastomer overmolded on the injection molded structural electronic component, the layer of polyurethane or thermoplastic elastomer providing an exterior surface of the assembly; an icon located in the layer of polyurethane or thermoplastic elastomer overmolded on the injection molded structural electronic component, the icon corresponding to the non-moveable switch, wherein illumination of the icon by the illuminating device causes the icon to be visible on the exterior surface of the assembly and the exterior surface of the assembly prevents the icon from being visible when it is not illuminated by the illuminating device.

### CROSS REFERENCE TO RELATED APPLICATIONS

This application claims the benefit of U.S. Provisional Patent Application Ser. No. 62/953,314 filed on Dec. 24, 2019 and U.S. Provisional Patent Application Ser. No. 62/953,316 filed on Dec. 24, 2019, the entire contents each of which are incorporated herein by reference thereto.

### BACKGROUND

Exemplary embodiments of the present disclosure pertain to the art of control icons and more particularly, an icon for use with a non-moving switch and a method of making a component with the switch.

Control icons are images an operator sees on pushbuttons that indicate what the function of that button is. Typically, these icons are very simplified two dimensional (2D) images, which are located on a moving switch (e.g., pushbutton, rocker or dial). Accordingly, it is desirable to provide a more aesthetically pleasing icon and surface associated with the icon.

### BRIEF DESCRIPTION

Disclosed is an assembly. The assembly, including: an injection molded structural electronic component, the injection molded structural electronic component including a non-moveable switch and an illuminating device; a layer of polyurethane or thermoplastic elastomer overmolded on the injection molded structural electronic component, the layer of polyurethane or thermoplastic elastomer providing an exterior surface of the assembly; an icon located in the layer of polyurethane or thermoplastic elastomer overmolded on the injection molded structural electronic component, the icon corresponding to the non-moveable switch, wherein illumination of the icon by the illuminating device causes the icon to be visible on the exterior surface of the assembly and the exterior surface of the assembly prevents the icon from being visible when it is not illuminated by the illuminating device.

In addition to one or more of the features described above, or as an alternative to any of the foregoing embodiments, the icon is a three dimensional icon.

In addition to one or more of the features described above, or as an alternative to any of the foregoing embodiments, the assembly is a portion of a vehicle interior.

In addition to one or more of the features described above, or as an alternative to any of the foregoing embodiments, the illuminating device is a light emitting diode (LED).

In addition to one or more of the features described above, or as an alternative to any of the foregoing embodiments, a layer of paint is applied to the exterior surface of the assembly.

In addition to one or more of the features described above, or as an alternative to any of the foregoing embodiments, the assembly includes a plurality of icons and a plurality of corresponding non-moveable switches.

Also disclosed is a method for providing an assembly with an illuminated icon. The method including the steps of: forming an injection molded structural electronic component; placing the injection molded structural electronic component in a tool; overmolding the injection molded structural electronic component with a polyurethane or thermoplastic elastomer layer to provide an exterior surface of the assembly; and forming the icon in the overmolded polyurethane or thermoplastic elastomer layer.

In addition to one or more of the features described above, or as an alternative to any of the foregoing embodiments, a paint is applied to the exterior of the assembly, wherein the paint prevents the icon from being viewed from the exterior surface unless the icon is illuminated with an illumination device located in the injection molded structural electronic component.

In addition to one or more of the features described above, or as an alternative to any of the foregoing embodiments, the overmolded polyurethane or thermoplastic elastomer layer is provided with a colorant, wherein the colorant prevents the icon from being viewed from the exterior surface unless the icon is illuminated with an illumination device located in the injection molded structural electronic component.

In addition to one or more of the features described above, or as an alternative to any of the foregoing embodiments, the icon is a three dimensional icon.

In addition to one or more of the features described above, or as an alternative to any of the foregoing embodiments, the assembly is a portion of a vehicle interior.

In addition to one or more of the features described above, or as an alternative to any of the foregoing embodiments, the illuminating device is a light emitting diode (LED).

In addition to one or more of the features described above, or as an alternative to any of the foregoing embodiments, the illuminating device is a light emitting diode (LED).

In addition to one or more of the features described above, or as an alternative to any of the foregoing embodiments, the icon is a three dimensional icon.

In addition to one or more of the features described above, or as an alternative to any of the foregoing embodiments, the assembly is a portion of a vehicle interior.

### BRIEF DESCRIPTION OF THE DRAWINGS

The following descriptions should not be considered limiting in any way. With reference to the accompanying drawings, like elements are numbered alike:

FIG. 1 is portion of a vehicle interior with a plurality of icons corresponding to a plurality of non-moving switches that are illuminated in accordance with an embodiment of the present disclosure;

FIG. 2 is portion of the vehicle interior of FIG. 1 wherein the plurality of icons corresponding to the plurality of non-moving switches are no longer illuminated in accordance with an embodiment of the present disclosure;

FIG. 3 is cross-sectional view of the portion of the vehicle interior illustrated in FIGS. 1 and 2; and

FIG. 4 is a flow chart illustrating a method for making a component in accordance with embodiments of the present disclosure.

### DETAILED DESCRIPTION

A detailed description of one or more embodiments of the disclosed apparatus and method are presented herein by way of exemplification and not limitation with reference to the Figures.

In accordance with the present disclosure, an assembly is provided. The assembly includes an injection molded structural electronic component that is overmolded with polyurethane or thermoplastic elastomer to provide a control surface that has a tactile feel and appearance, which some embodiments is similar to that of the surrounding trim in the interior of the vehicle.

Injection molded structural electronics use multiple printed film layers and injected polymer between layers. These injection molded structural electronics provide a very hard exterior surface. As such and in order to provide a control surface that has a tactile feel and appearance similar to that of surrounding trim parts, an electronic component such as an injection molded structural electronic part or flexible circuit is placed in a tool and is overmolded with a polyurethane or thermoplastic elastomer. In one embodiment, the polyurethane or thermoplastic elastomer is of a type that is naturally clear, however and in order to obscure the underlying electronics colorants are added to the polyurethane or thermoplastic elastomer. Accordingly, a component or assembly with a soft exterior surface is capable of being formed with an injection molded structural electronics and an overmolded layer of polyurethane or thermoplastic elastomer.

In another exemplary embodiment of the present disclosure, the polyurethane or thermoplastic elastomer is transparent and is then coated with a paint that provides color to an exterior surface of the formed component that hides the underlying electronics of the injection molded structural electronics.

The result from any of the aforementioned embodiments is a structure, assembly or component that provides a hidden front capability. In other words and when an image or icon of the assembly or component is illuminated, sufficient light goes through the structure, assembly or component (e.g., the layer of polyurethane or thermoplastic elastomer) to identify the symbol. When the source of illumination is off, light on the exterior surface of the assembly largely reflects off the exterior surface of the polyurethane or thermoplastic elastomer and no symbol is seen.

As such, an assembly, component or interior portion or interior trim portion of a vehicle is provided wherein an injection molded structural electronic part is overmolded with a layer of polyurethane or thermoplastic elastomer in order to provide the component or interior portion or interior trim portion of a vehicle with a soft exterior surface that includes icons that are viewable from the exterior surface when illuminated and no longer visible when icons are not illuminated.

In one embodiment, a switch of the injection molded structural electronic part or flexible circuit does not move and includes a capacitive sensor that may be used for the switch associated with the icon. The injection molded structural electronic part will also comprise a means for illuminating or illuminating device for illuminating the injection molded structural electronic part or flexible circuit such that indicia provided in the overmolded layer of polyurethane or thermoplastic elastomer is viewable from an exterior show surface of the component.

In one embodiment, the means for illuminating or illuminating device is a light emitting diode or diodes that can be either forward facing or side emitting light emitting diodes LEDs. Therefore and when a switch embedded into the overmolded layer of polyurethane or thermoplastic elastomer is illuminated it is viewable from an exterior show surface of the component and the exterior show surface of the component has an aesthetically pleasing appearance and also provides a tactile feel and appearance, which in some embodiments is similar to that of the surrounding trim in the interior of the vehicle.

As discussed above, the switch is a non-moveable switch or sensor or capacitive sensor or other equivalent device that when is placed in close proximity to an operator's finger a switch or circuit is closed without any components moving. In one non-limiting embodiment, the structure or component may be a portion of a vehicle interior such as instrument panel or console or center console or armrest of the vehicle and the injection molded structural electronic part is provided with the non-moveable switch or sensor and the means or device for illuminating the icon. In one embodiment, the means or device for illuminating is a light emitting diode (LED).

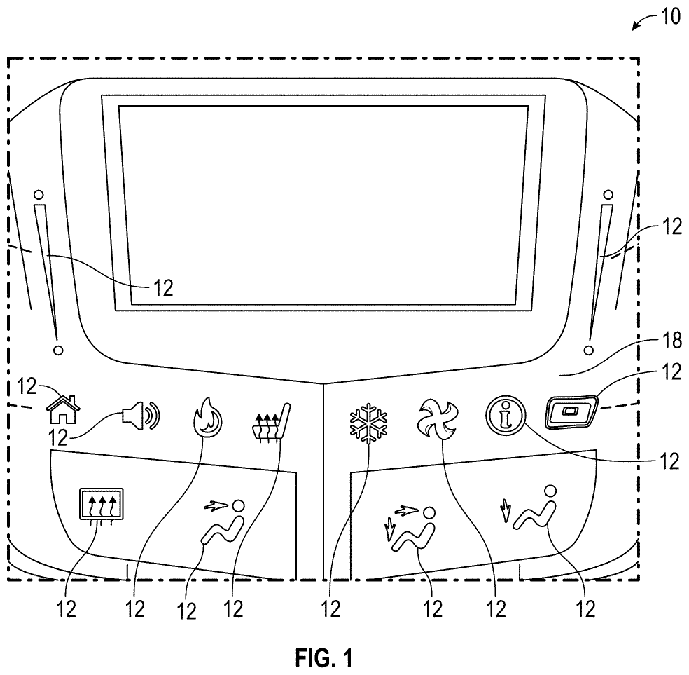

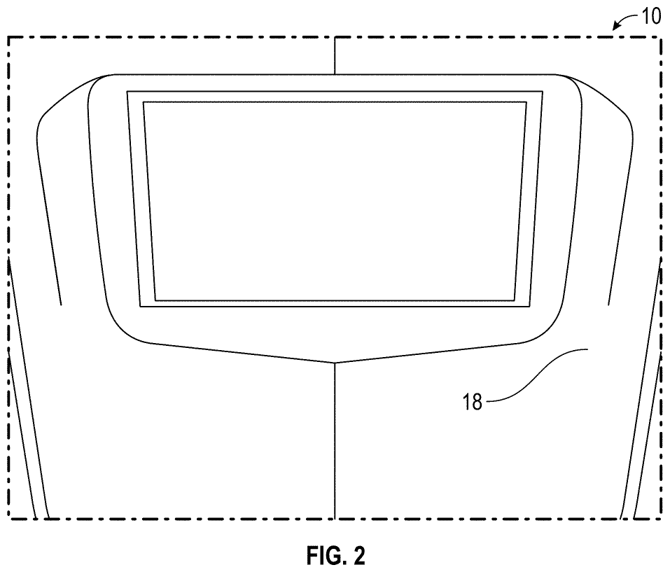

Referring now to FIG. 1, a portion 10 of a vehicle interior with a plurality of icons 12 corresponding to a plurality of non-moving switches that are illuminated in accordance with an embodiment of the present disclosure is illustrated. In FIG. 2, the portion 10 of the vehicle interior is no longer illuminated and the plurality of icons corresponding to the plurality of non-moving switches are no longer illuminated. In one embodiment, the icons 12 may be formed as three dimensional icon or icons in a layer of polyurethane or thermoplastic elastomer 16.

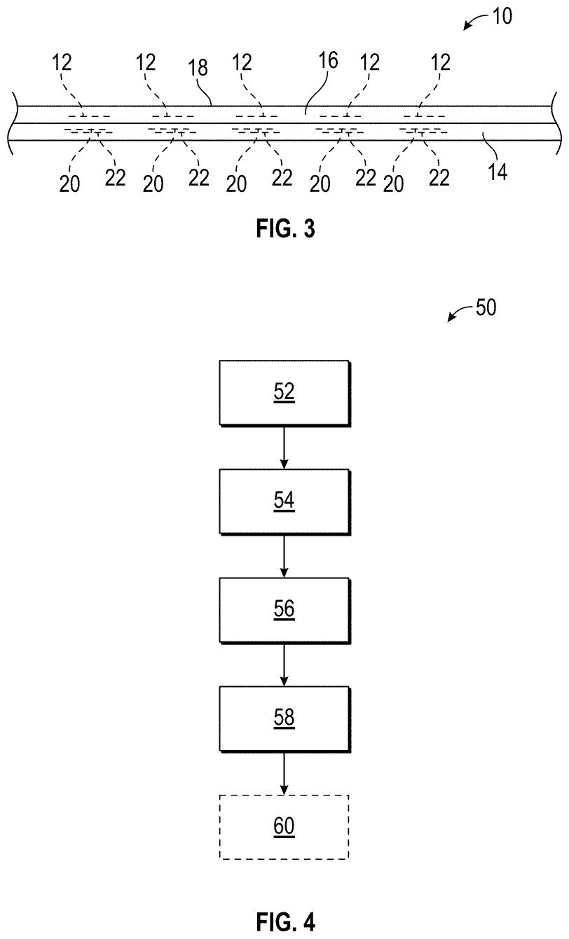

FIG. 3 is cross-sectional view of the portion 10 of the vehicle interior illustrated in FIGS. 1 and 2. This portion 10 may also be referred to as an assembly 10 or component 10 or interior trim 10 of a vehicle. As illustrated, an injection molded structural electronic component 14 of the assembly 10 is overmolded with a polyurethane or thermoplastic elastomer layer 16 to provide a control surface 18 that has a tactile feel and appearance, which some embodiments is similar to that of the surrounding trim in the interior of the vehicle. In addition and in one embodiment, the icons 12 will be formed in the polyurethane or thermoplastic elastomer layer 16. Alternatively, the icons 12 may be formed in a layer of the injection molded structural electronic component 14. In yet another embodiment, the icons may be formed in both the polyurethane or thermoplastic elastomer layer 16 and the injection molded structural electronic component 14.

As mentioned above, the injection molded structural electronic component 14 comprises multiple printed film layers and injected polymer between layers, which will include a non-contact sensor or switch 20 such as a capacitive switch that corresponds to a respective icon 12. In one embodiment, the injection molded structural electronic component 14 may also comprise a means for illuminating 22 the icons 12. As discussed above and in one embodiment, the means for illuminating or illuminating device 22 may be a light emitting diode 22.

Referring now to FIG. 4 a flow chart 50 is provided for illustrating a method for making a component 10 or assembly 10 in accordance with embodiments of the present disclosure. In a first step 52, an injection molded structural electronic component 14 is formed. Thereafter and in a second step 54, the injection molded structural electronic component 14 is placed in a tool. Thereafter and in a third step 56, the injection molded structural electronic component 14 is overmolded with a polyurethane or thermoplastic elastomer layer 16. Thereafter and in a fourth step 58, the icons 12 are formed in the overmolded polyurethane or thermoplastic elastomer layer 16. If the polyurethane or thermoplastic elastomer layer 16 is not provided with colorants an optional fifth step 60 may be used to apply a paint to an exterior of the formed component that provides color to the formed component and hides the underlying electronics.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An assembly, comprising:
an injection molded structural electronic component, the injection molded structural electronic component including a non-moveable switch and an illuminating device;
a layer of polyurethane or thermoplastic elastomer overmolded on the injection molded structural electronic component, the layer of polyurethane or thermoplastic elastomer providing an exterior surface of the assembly;
an icon located in the layer of polyurethane or thermoplastic elastomer overmolded on the injection molded structural electronic component, the icon corresponding to the non-moveable switch, wherein illumination of the icon by the illuminating device causes the icon to be visible on the exterior surface of the assembly and the exterior surface of the assembly prevents the icon from being visible when it is not illuminated by the illuminating device.

2. The assembly as in claim 1, the icon is a three dimensional icon.

3. The assembly as in claim 1, wherein the assembly is a portion of a vehicle interior.

4. The assembly as in claim 1, wherein the illuminating device is a light emitting diode (LED).

5. The assembly as in claim 1, wherein a layer of paint is applied to the exterior surface of the assembly.

6. The assembly as in claim 1, wherein the assembly comprises a plurality of icons and a plurality of corresponding non-moveable switches.

7. A method for providing an assembly with an illuminated icon, comprising:
forming an injection molded structural electronic component;
placing the injection molded structural electronic component in a tool;
overmolding the injection molded structural electronic component with a polyurethane or thermoplastic elastomer layer to provide an exterior surface of the assembly; and
forming the icon in the overmolded polyurethane or thermoplastic elastomer layer.

8. The method as in claim 7, further comprising applying a paint to the exterior of the assembly, wherein the paint prevents the icon from being viewed from the exterior surface unless the icon is illuminated with an illumination device located in the injection molded structural electronic component.

9. The method as in claim 7, wherein the overmolded polyurethane or thermoplastic elastomer layer is provided with a colorant, wherein the colorant prevents the icon from being viewed from the exterior surface unless the icon is illuminated with an illumination device located in the injection molded structural electronic component.

10. The method as in claim 7, the icon is a three dimensional icon.

11. The method as in claim 7, wherein the assembly is a portion of a vehicle interior.

12. The method as in claim 8, wherein the illuminating device is a light emitting diode (LED).

13. The method as in claim 9, wherein the illuminating device is a light emitting diode (LED).

14. The method as in claim 8, the icon is a three dimensional icon.

15. The method as in claim 9, wherein the assembly is a portion of a vehicle interior.
